(19) United States
(12) Patent Application Publication
(10) Pub. No.: US 2005/0217791 A1
(43) Pub. Date: Oct. 6, 2005

(54) Two-step registered printing

(75) Inventors: John Patrick Costello, Neenah, WI (US); John Jerome Schmid, Sherwood, WI (US); Eric Donald Johnson, Larsen, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/813,873

(22) Filed: Mar. 31, 2004

(51) Int. Cl. B32B 31/00; B41J 2/01; B41J 15/00; C09J 5/00; B41M 1/26

(52) U.S. Cl. 156/277; 101/483; 347/16; 156/324

(57) ABSTRACT

A method of printing a substrate includes contact printing a first graphic in a first operation and non-contact printing a second graphic in a second operation. A method of printing an outer cover for an absorbent article includes contact printing the outer cover in a first operation, non-contact printing the outer cover in a second operation, and joining the outer cover with an absorbent and a liner to produce an absorbent article. A method of minimizing substrate printing waste includes contact printing absence advertisements in a first operation and non-contact overprinting a second graphic in a second operation. A method of distributing customized products to different customers includes contact printing substantially uniform graphics on a substrate in a first operation, non-contact printing customized graphics on a substrate in a second operation, and distributing the substrate to customers.

### BACKGROUND OF THE INVENTION

Graphics are commonly printed on articles of manufacture to increase their aesthetic appeal. One example of this is graphics or images printed on absorbent garments, such as infant and children's diapers and training pants. The outer covers of these articles are frequently imprinted with brightly colored images in the form of designs and characters that are pleasing to the child and caregiver. Images may also be printed on other absorbent articles such as feminine healthcare products, adult incontinence garments and bandages. However, graphics are not exclusive to personal care products, and could be, for example, applied to a cleaning wipe or sheet product.

Traditionally, printing the outer cover material or other portion of an article with an image has been carried out by flexographic printing, rotogravure printing, screen printing, offset printing, or other types of contact printing techniques prior to assembly of the absorbent article (i.e., the printing is done “off-line”). Typically, the image is printed on the outer cover material before being moved or shipped to the location where the absorbent article is assembled. While printing an image during the manufacture of absorbent articles (i.e., printing “on-line”), by use of traditional contact printing processes, is possible, it has traditionally not been practical. Contact printing on-line can be difficult, time-consuming, and costly. These problems can be exacerbated when there is a desire to change the printed image. Changing the image typically requires shutting down the entire assembly process and installing new print rolls, screens, or plates. Additionally, contact printing on-line may create a significant amount of waste and delay during startup, shutdown, and other transitory process changes and therefore does not lend itself to the on-line manufacture of mass produced absorbent articles.

Non-contact printing systems are known to provide flexibility in image printing and typically include ink jet printing, wax jet printing, bubble jet printing, laser jet printing, and the like. Changing from one image to the next may be done rapidly without stopping the process. Drop on demand piezoelectric ink jet printing apparatus have been used to apply inks to a variety of substrates. Generally, a drop on demand piezoelectric ink jet printing apparatus discharges small individual droplets of ink onto a substrate in a predetermined pattern. In this type of apparatus, the print head does not contact the web on which it prints.

However when the substrate is running under the print head at higher speed (e.g., 100 feet per minute or greater), it is very difficult for the print head to be controlled or supply an adequate amount of ink such that a large number of dots per inch (dpi) can be accurately applied. This is particularly true where, as a result of the operation of the absorbent garment assembly apparatus, the image must be formed in a single pass of the material under the print heads. Non-contact printing is further complicated when wider patterns are desired. Typically when using a non-contact printer to create a wide pattern, additional banks of print heads are required to achieve the graphics desired. Consequently, while there has been progress in the area of non-contact printing, the printers have been limited in that they were not able to produce an image of a commercially acceptable quality at higher speeds encountered in the assembly of an absorbent garment such as a diaper or training pant.

Additionally, on-line non-contact printing can result in significant waste.

Specifically, when a substrate, intended for use as a component of an absorbent article, encounters a printing failure, the entire absorbent article is usually discarded as defective. This increases the amount of waste that results from printing failures.

In view of the aforementioned problems, there arises the need for a method of printing high quality images on substrates that is cost effective and minimizes waste associated with printing failures.

### SUMMARY OF THE INVENTION

In response to the discussed difficulties and problems encountered previously, the present invention provides methods of printing a moving substrate, methods of printing an outer cover for an absorbent article, methods of minimizing substrate printing waste, and methods of distributing customized products to different customers.

One embodiment for printing a moving substrate includes the steps of: supplying a moving substrate to a first converting operation, contact printing at least one first graphic on the moving substrate, supplying the moving substrate with the first graphic to a second converting operation, and non-contact printing at least one second graphic on the moving substrate.

In various embodiments, a gravure printer, flexographic printer, offset printer, or screen printer may be used for the contact printing. A wax jet printer, ink jet printer, laser jet printer, or bubble jet printer may be used for the non-contact printing. The first graphic and second graphic may jointly form a story line. The moving substrate may be traveling at least 100 feet per minute during the non-contact printing.

In various embodiments, at least one third graphic may be non-contact printed on the moving substrate and at least a portion of the third graphic may at least partially overprint the first graphic. The second graphic may at least partially overprint the first graphic. The first graphic and the second graphic may jointly form a master graphic.

The second converting operation may produce disposable absorbent articles and the moving substrate may form an outer cover of the articles in some embodiments. The moving substrate may form a bodyside liner of the disposable absorbent articles in some embodiments. The moving substrate may form an absorbent of the disposable absorbent articles is some embodiments.

The substrate may be a laminate made of a film layer and a nonwoven layer and the first graphic may be printed on the film layer and the second graphic may be printed on the nonwoven layer. Alternatively, the substrate may be a laminate made of a film layer and a nonwoven layer and the first graphic may be printed on the nonwoven layer and the second graphic may be printed on the nonwoven layer. Alternatively, the substrate may be a laminate made of a film layer and a nonwoven layer and the first graphic may be printed on the film layer and the second graphic may be printed on the film layer.

One embodiment for printing an outer cover for an absorbent article includes the steps of: supplying a moving first substrate to a first printing operation, the first moving substrate comprising a film; contact printing at least one first graphic on the first moving substrate in the first printing operation using a gravure roll printer or flexographic printer; laminating a second moving substrate to the first moving substrate to form an outer cover, the second moving substrate comprising a nonwoven web and the outer cover defining a width; supplying the outer cover to a second printing operation; non-contact printing at least one second graphic on the outer cover in the second printing operation using a wax jet printer, ink jet printer, bubble jet printer, or laser jet printer, the first graphic spanning at least 60% of the width of the outer cover and being visible to the naked eye, the second graphic being positioned within the center third of the width of the outer cover and being visible to the naked eye; and joining the outer cover with an absorbent and a liner to produce an absorbent article.

The absorbent article may have a front waist region, a back waist region, and a crotch region connecting the front waist region and the back waist region. In such an article, the second graphic may be positioned within the front waist region. Alternatively, the second graphic may be positioned within the back waist region. Alternatively, the outercover may have two or more second graphics arranged such that at least one second graphic is positioned within the front waist region and at least one second graphic is positioned within the back waist region of the absorbent article.

One embodiment for minimizing substrate printing waste includes the steps of: supplying a moving substrate to a first converting operation; contact printing a plurality of absence advertisements on the moving substrate; supplying the moving substrate with the absence advertisements to a second converting operation; at least partially overprinting second graphics on at least some of the absence advertisements using a non-contact printer, wherein a failure to print a second graphic on an absence advertisement results in the absence advertisement remaining visible on the substrate. In various aspects of this embodiment, the substrate may be joined to an absorbent and to a liner to form an absorbent article in which the absence advertisement forms part of an interactive game or contest involving the user of the absorbent article. Alternatively, the absence advertisement may convey contact information to a consumer of the absorbent article.

One embodiment of printing an outer cover for an absorbent article includes the steps of: laminating a first substrate made of film to a second substrate made of a nonwoven to form an outer cover, the outercover defining a film side, a nonwoven side opposite the film side, and a width; supplying the outer cover to a printing process and contact printing at least one first graphic on the nonwoven side; supplying the outer cover to a converting operation, the converting operation combining the outer cover with an absorbent assembly to form an absorbent article; non-contact printing at least one second graphic on the nonwoven side in the converting operation, the first graphic spanning at least 60% of the width of the outer cover and being visible to the naked eye, the second graphic being positioned within the center third of the width of the outer cover, and both first and second graphics being visible to the naked eye.

One embodiment of distributing customized products to different customers includes the steps of: supplying a moving substrate to a first converting operation; contact printing at least one first graphic on the moving substrate, the first graphic being substantially uniform to all customers; supplying the moving substrate with the first graphic to a second converting operation; non-contact printing a plurality of second graphics on the moving substrate, the plurality of second graphics being customized for specific customers; and distributing the substrate to customers. In various embodiments, the customized graphics may be different languages for geographically differentiated customers. In other embodiments, the customized graphics may be different indicia for business customers.

### BRIEF DESCRIPTION OF THE DRAWINGS

FIG. 1 representatively illustrates a plan view of one embodiment of an exemplary method.

FIG. 2 representatively illustrates a vertical section view of an exemplary gravure printing process.

FIG. 3 representatively illustrates a vertical section view of an exemplary wax jet printing process.

FIG. 4 representatively illustrates a perspective view of an exemplary diaper.

FIG. 5 representatively illustrates a plan view of one embodiment of a substrate including exemplary graphics.

FIG. 6 representatively illustrates a plan view of one embodiment of a substrate including exemplary graphics.

FIG. 7 representatively illustrates a plan view of one embodiment of a substrate including exemplary graphics.

FIG. 8 representatively illustrates a plan view of one embodiment of a substrate including exemplary graphics.

### DETAILED DESCRIPTION OF THE DRAWINGS

One aspect of the present invention relates to a method of printing substrates. More specifically, one aspect relates to a method of printing a first graphic on a moving substrate using a contact printing method, such as, for example, flexographic printing, rotogravure printing, offset printing, lithographic printing, screen printing, or the like. The method also involves printing the substrate using a non-contact printing method, such as, for example, wax jet printing, ink jet printing, bubble jet printing, laser jet printing, or the like. In some embodiments, the method further includes the step of producing a disposable absorbent article with one or more of the printed substrates. The substrates can be used as an outer cover, liner, side panel, flaps, absorbent, or combinations thereof in disposable absorbent articles. As used herein, the term “print” or “printing” means to make an image on something. Frequently, printing involves formation of an image by the transfer of pigment, colorant, or brightener in the form of ink, wax, paint, or the like. The printed image is visible to the human eye and can include, for example, shapes, patterns, designs, objects, likenesses of real or fictitious characters, or the like, or combinations thereof. For example, printing can include the direct transfer of pigment from a print roll, plate, or screen to the substrate. Printing can also include the deposit of pigment from a pigment source on a substrate without direct contact between the pigment source and the substrate, such as, for example from ink jet printers, wax jet printers, bubble jet printers, laser jet printers, or the like, or combinations thereof. As used herein, the term “substrate” means a web of material capable of moving through a machine. A substrate can include contiguous material wherein individual units of material are connected or directly joined to the immediately preceding and trailing units of material. For example, a substrate may include a continuous web of woven material, nonwoven material, film, or the like, or combinations thereof. A substrate may also include interconnected absorbent articles in various stages of manufacture. A substrate may also include a web of discrete units of material separated by space or by other materials. For example, a substrate may include discreet absorbent articles moving through a converting operation via one or more conveyor belts or other means of conveyance known in the art.

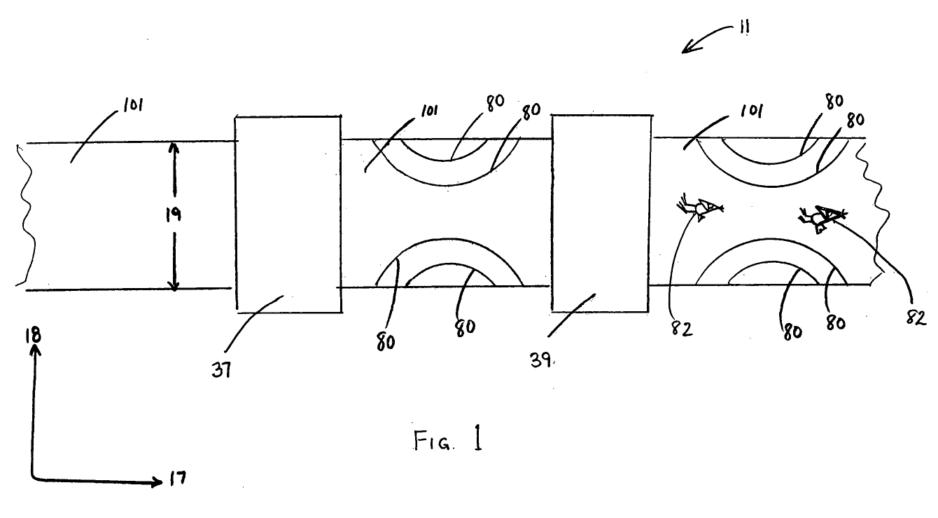

One embodiment of the method is generally illustrated at 11 in FIG. 1. In FIG. 1, a moving substrate 101 is supplied to a first converting operation 37. The substrate 101 has a machine direction 17, a cross machine direction 18, and a width 19. The width 19 is measured in the cross machine direction 18. The first converting operation 37 prints at least one first graphic 80 on the substrate 101. The substrate 101 is then supplied to a second converting operation 39. The second converting operation 39 prints at least one second graphic 82 on the substrate 101. In various embodiments, the number of converting operations may be 3, 4, 5, 6, 7, 8, 9, 10, or more than 10. In various embodiments, the substrate 101 may be slit and/or wound and then transported to the second converting operation 39 wherein the substrate 101 is unwound or otherwise delivered to the second converting operation 39.

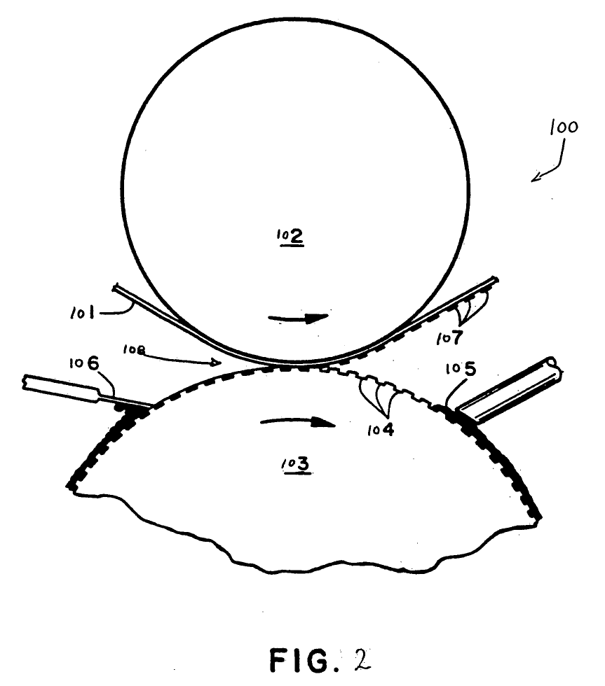

In various embodiments, the first converting operation 37 may be a traditional contact printing process. Contact printing has traditionally been an economical way to print large and/or wide patterns on a substrate with reproducible results. However, contact printing may result in higher initial expense because the specific pattern rolls, plates, or screens must be manufactured. Because of the custom manufacturing, subsequent changes to the print pattern may require the manufacture of new equipment and may limit the economic feasibility of quickly changing the print pattern for specific needs or limited production situations. As used herein, “contact printing” refers to a form of printing in which the substrate is directly contacted by the printing apparatus. For example, the first converting operation 37 may include a gravure process as generally illustrated at 100 in FIG. 2. Printing via a gravure process would be an example of contact printing. In the gravure process 100, a substrate 101 is passed between a rubber impression roller 102 and a gravure cylinder 103. The surface of the gravure cylinder contains a large number of depressions or cells 104, which are designed to receive, hold, and transfer colorant to the substrate 101. Colorant or brightener 105 is applied to the surface of the gravure cylinder 103 downstream of a nip 108 and is removed from the land areas of the gravure cylinder with a doctor blade 106. As the substrate 101 enters the nip 108, it is pressed against the gravure cylinder 103 by the rubber impression roller 102, thereby permitting the colorant or brightener 105 to transfer from the gravure cylinder cells 104 and be deposited on the surface of the substrate 101 in small colored or brightened areas 107 corresponding to the individual gravure cylinder cells 104. When printing with inks, the overall pattern of small colored or brightened areas remains relatively intact in the final substrate. In such instances, the percentage of the surface area of the substrate 101 covered by the colored areas will closely match the percentage of the surface area of the gravure roll covered by the gravure cells. The gravure process 100 uses an engraved print roll 103 that increases the life of the print pattern and provides higher definition when printing on plastic substrates. Additionally, gravure equipment can be used with water-based, solvent-based, and hot-melt, adhesive-based inks, or the like.

The first converting operation 37 may alternatively comprise flexographic printing as is well known in the art. Flexographic printing provides high speed, high quality printing suitable for printing nonwoven fibrous webs, while maintaining the tactile softness of the web. Flexography is a printing technology, which uses flexible raised rubber or photopolymer plates to carry the image to a given substrate. The flexible plates carry a typically low-viscosity ink directly onto the substrate. The quality of flexographic print in recent years has rapidly advanced such that, for many end-uses, it is comparable to lithographic or gravure printing.

The types of plates that can be used with the process include, but are not limited to, plates identified as DuPont Cyrel.RTM.HL, PQS, HOS, PLS, and LP, which may be obtained from E. I. DuPont de Nemours & Co., Inc., 1007 Market Street, Wilmington, Del. 19898, U.S.A.; a plate identified as BASF Nyloflex.RTM., which may be obtained from BASF, 1255 Broad Street, Clifton, N.J. 07015, U.S.A.; and a plate identified as Flex-light. RTM. type FL-SKOR.RTM., which may be obtained from W.R. Grace & Co., 5210 Phillip Lee Drive, Atlanta, Ga. 30336, U.S.A. Others include laser etched vulcanized rubber cylinders, such as those supplied by Luminite Products Corporation, 115 Rochester Street, Salamanca, N.Y. 14779, U.S.A. or by Flexo Express, 270 Rochester Street, Salamanca, N.Y. 14779, U.S.A.; or rubber printing plates, such as those supplied by Fulflex, Incorporated, P.O. Box 4549, Middleton, Rhode Island 02804, U.S.A. The rubber plates and vulcanized cylinder could be natural rubber, EPDM, nitrites, or urethanes.

The first converting operation 37 may alternatively comprise lithographic printing, offset printing, or screen printing as is well known in the art. Lithographic printing is based on the immiscibility of oil and water. Ink receptive areas are generated on the surface of a hydrophilic surface. When the surface is moistened with water and then ink is applied, the hydrophilic background areas retain the water and repel the ink and the ink receptive areas accept the ink and repel the water. The ink is transferred to the surface of a material upon which the image is to be reproduced. Typically, the ink is first transferred to an intermediate blanket, which in turn transfers the ink to the surface of the material upon which the image is to be reproduced. The screen printing process typically forces ink through unblocked areas of a metal, synthetic or silk fiber screen by spreading the ink onto the screen and passing a squeegee over the screen thus forcing the ink onto the substrate. Offset printing typically involves a transfer roll that is capable of being rotated.

An ink source is located proximate to the transfer roll and dispenses ink onto the transfer roll. A web is present and contacts the transfer roll. The substance is dispensed onto the transfer roll and is transferred to the web through contact of the transfer roll and the web. In various embodiments, the second converting operation 39 may include a manufacturing line for absorbent articles, such as, for example, a diaper converting operation. As such, the second converting operation 39 may utilize a non-contact ink jet printing process to print at least one second graphic 82 on the previously printed substrate 101. Use of ink jet printing is well suited to producing fine patterns with high detail. Ink jet printing also allows rapid changes to the pattern with only a change in programming versus fabrication of new printing rolls, screens, or plates. However, non-contact printing may not be optimum for producing wide patterns or patterns requiring a large quantity of ink expenditure. As used herein, “non-contact printing” refers to a form of printing in which an image is formed on a substrate without direct contact between the substrate and the apparatus producing the image.

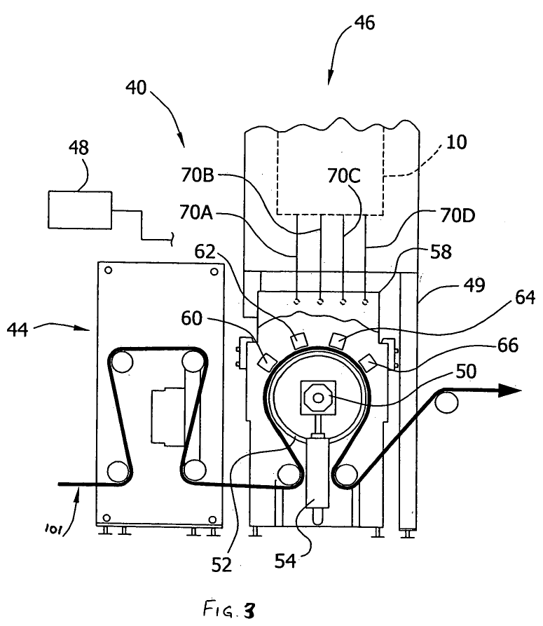

As an example of non-contacting printing, the second converting operation 39 may include an ink jet printing process as generally illustrated at 46 in FIG. 3. The ink jet process 46 includes apparatus 40 that may be used for printing at least one second graphic 82 on substrate 101. The substrate 101 may be used as an outer cover, liner, side panel, flap, absorbent or combinations thereof. Additionally, the substrate 101 may be a complete or partially complete diaper or other absorbent article. The second graphic 82 may be printed on various locations on the article, such as, for example, the outer cover, side panel, liner, flap or combinations thereof. For purposes of this disclosure, the substrate 101 will be illustrated as an outer cover for an absorbent article, such as a diaper. Thus, the second graphic 82 may be formed in the same process as the assembly of the various components of the diaper. However, in particular embodiments, the first and second converting operation can include printing and not the assembly of an absorbent article. The composition and configuration of diapers and diaper converting operations are well understood by those of ordinary skill in the art and are representatively disclosed by way of illustration in U.S. Pat. No. 5,743,994 issued Apr. 28, 1998 to Roessler et al., U.S. Pat. No. 5,827,387 issued Oct. 27, 1998 to Reynolds et al., U.S. Pat. No. 5,827,259 issued Oct. 27, 1998 to Laux et al., and U.S. Pat. No. 5,853,402 issued Dec. 29, 1998 to Faulks et al., the entirety of each is incorporated herein by reference where not contradictory. Referring to FIG. 3, the outer cover material may be fed from a roll (not shown) as a substrate 101 to a guide 44, then to an ink jet printing station 46 and thereafter to the assembly line (not shown). A controller 48 can be used to control the operation of the apparatus 40, and in particular the operation of the ink jet printing station 46. In a particular aspect, a web guide 44 can be used to monitor the cross machine direction position of the substrate 101 to maintain it in a controlled position just prior to entering the printing station 46. An example of a suitable web guide is the Symat 50 Offset Pivot Guide available from Fife Corporation of Oklahoma City, Okla., U.S.A.

The illustrated ink jet printing station 46 includes a frame 49 which supports bearings 50 (only one is shown) holding a print drum 52 for rotation about a generally horizontal axis. A suitable bearing would be a model number F4BDL200 manufactured by Dodge Bearings Incorporated of Greenville, S.C., U.S.A. These bearings 50 provide resistance to vibration of the drum 52, which is particularly likely to occur during start up and shut down of the diaper assembly apparatus. Vibrations can cause the image to appear fuzzy to the point that diapers may have to be discarded as commercially unacceptable in the absence of vibration control. The bearings 50 supporting the print drum 52 for rotation can be mounted for slidingly adjustable vertical movement in the frame 49. Two electrically driven linear motion actuators 54 (only one is shown), on opposite sides of the frame 49, can be connected to the print drum bearings 50 for moving the bearings and the print drum 52 relative to the frame. A suitable linear actuator is a Model GSX30 manufactured by Exlar Corporation of Chanhassen, Minn., U.S.A.

An on demand piezoelectric ink jet printing unit may include a housing 58 mounted on the frame 49. The illustrated housing 58 supports first through fourth print heads (designated 60, 62, 64, 66, respectively), arranged along an upper portion of the circumference of the print drum 52 although any number of print heads may be used. The print heads 60-66 are located in a series along the circumference portion. The lower ends of the print heads 60-66 (from which the ink droplets are discharged) may be spaced closely with the drum 52. As an example, the print heads 60-66 can be spaced from the drum 52 so that the spacing between the upper surface of the substrate 101 and the print heads is between about 1 mm (0.04 in) and about 3 mm (0.12 in). In one embodiment, the cylinders 54 move the print drum 52 so that in operation, the spacing of each print head 60-66 from the web is about 1 mm (0.04 in) to 3 mm (0.12 in) in operation, and is larger when not in use for facilitating threading the substrate 101 material through the ink jet printing apparatus 46. Movement is accomplished by the linear actuators 54.

Although other inks could be used to print the second graphic 82, it has been found that thermochromic or phase change inks, such as wax-based inks have certain advantages in that these inks have reduced tendencies to spread and smear and do not require time or equipment for drying, which is highly desirable in a manufacturing context. These types of inks also do not require the use of solvents. Wax-based inks are received in solid blocks that are melted in an ink supply system 70, schematically illustrated as being mounted on the frame 49. The melted ink of a particular color is fed through a respective one of four lines (designated 70A, 70B, 70C, 70D, respectively) to one of the print heads 60, 62, 64, 66, as demanded by the print head. One suitable system for melting and supplying the ink is the DYNAMELT® S Series hot melt supply system available from ITW Dynatec of Hendersonville, Tenn., U.S.A. This system, marketed for supplying adhesives, can be modified for supplying melted ink. In one embodiment, the system includes a metered gear pump (not shown) for precise delivery of ink, which gear pump includes stainless steel components in contact with the ink. Moreover, the commercially available system can be further modified by adding a 10 micron filter. Other filter sizes may be used as specified by the print head vendor or ink vendor. The ink supply system controls the temperature of the ink. In one embodiment, the melted ink is maintained at about 125° F. (51.7° C.). The temperature may be controlled to any level specified by the ink vendors or the print head vendors.

Suitable print heads 60, 62, 64, 66 that may be used in one embodiment to produce an image are Galaxy PH 256/80 HM 256 channel ink jet print heads (Serial Nos. 5601320, 5601325, 5601326, 5601327) available from Spectra, Inc. of Lebanon, New Hampshire, U.S.A. These print heads 60-66 each have two piezoelectric crystals with each crystal having two independent electrical circuits. Each circuit is associated with 64 orifices for a total of 256 orifices per print head. Each of the orifices can be individually addressed so that the controller 48 can select which of the 256 orifices are to be fired in each cycle. The orifices are spaced apart about 0.0254 centimeter (0.01 inch)±0.00245 centimeter (0.001 inch). It will be understood that other print heads having a different number of orifices and/or orifices with different spacings could be used without departing from the scope of the present invention. A longer print head would allow a wider (in the cross direction of the outer cover material) image to be printed. Moreover, print heads may be banked (placed side-by-side in the cross direction) to print a wider image. The print heads 60-66 can each have an ink reservoir on the print head that has an ink level sensor that can be used to signal the ink supply system 70 to deliver additional ink to the print head.

Application of ink by ink jet print heads to high speed substrates is also discussed in Sharma et al., U.S. patent application Ser. No. 10/330,515, entitled HIGH-SPEED INK JET PRINTING FOR VIBRANT AND CROCKFAST GRAPHICS ON WEB MATERIALS OR END-PRODUCTS, filed Dec. 27, 2002, the entirety of which is incorporated herein by reference where not contradictory. Other suitable apparatus, ink types, color measurements, and design techniques are also discussed in Anderson et al, U.S. patent application Ser. No. 10/623,030, entitled ABSORBENT ARTICLE WITH HIGH QUALITY INK JET IMAGE PRODUCED AT LINE SPEED, filed Jul. 18, 2003, the entirety of which is incorporated herein by reference where not contradictory.

In various embodiments, the substrate 101 may be moving at least 100 feet per minute (fpm) during the non-contact printing operation 46 in the second converting operation 39. Alternatively, the substrate 101 may be moving at least 200 fpm, 300 fpm, 400 fpm, 500 fpm, 600 fpm, 700 fpm, 800 fpm, 900 fpm, or 1000 fpm during the non-contact printing operation 46 in the second converting operation 39. In various other embodiments, the substrate 101 may be moving faster than 1000 fpm during the non-contact printing operation 46 in the second converting operation 39.

In various embodiments, the first converting operation 37 may include multiple contact printing steps wherein one or more colors or patterns are applied. The first converting operation 37 may also include contact or non-contact printing or may be a combination of contact and non-contact printing. Additionally, the second converting operation 39 may include multiple contact printing steps, non-contact printing steps, or combinations thereof.

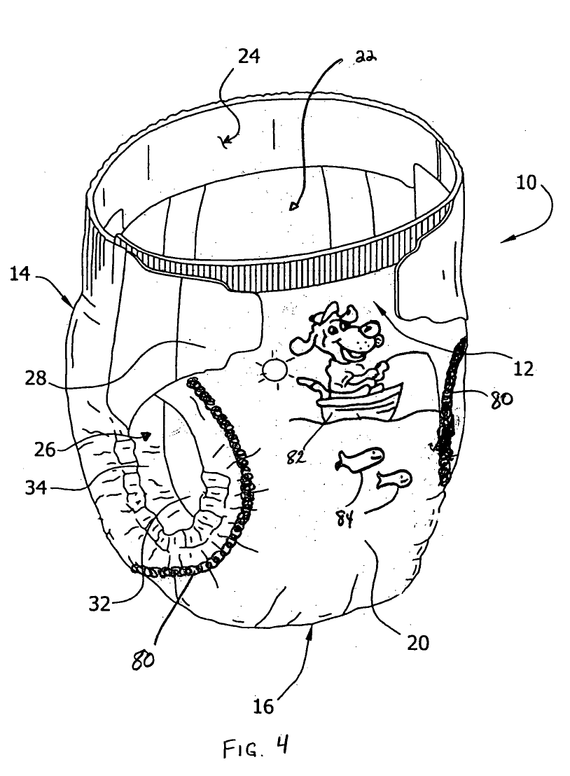

It will be readily appreciated that the methods of the present invention may be utilized with various substrates such as, for example, absorbent garments, personal care products, textiles, cloth, paper, wovens, nonwovens, films and the like. Referring now to FIG. 4, an absorbent garment in the form of a diaper (indicated generally at 10) having at least one first image 80 and at least one second image 82 may be formed by the method of the present invention. The diaper 10 comprises a front waist region 12, a back waist region 14, and an intermediate crotch region 16 interconnecting the front and back waist regions. The waist regions 12 and 14 comprise those portions of the diaper 10 which when worn, wholly or partially cover or encircle the waist or mid-lower torso of the wearer. The intermediate crotch region 16 lies between and interconnects the waist regions 12 and 14, and comprises that portion of the article 10 which, when worn, is positioned between the legs of the wearer (not shown) and covers the lower torso of the wearer. The exterior of the diaper 10 is formed substantially by an outer cover 20 constructed to form a liquid barrier.

The diaper 10 has a generally three-dimensional configuration, as illustrated in FIG. 4, when fastened on a wearer. In this configuration the diaper has an interior space 22 for receiving the lower torso of a person wearing the diaper, a waist opening 24 for receiving the wearer into the interior space of the diaper, and a pair of leg openings 26 (only one is shown). In the illustrated embodiments, the fastener tabs 28 are permanently attached to a back waist region 14 of the diaper. These tabs 28 may be releasably attached to the front waist region 12 of the diaper 10 for securing the diaper around the lower torso of the wearer. Other fastening systems (not shown) may be employed without departing from the scope of the present invention.

The diaper 10 generally includes a bodyside liner 32 on its innermost surface that contacts the skin of the person wearing the diaper 10. The liner 32 is desirably a soft, compliant material which is highly liquid permeable and hydrophobic to permit passage of liquid through the liner and to maintain a relatively dry surface contacting the skin. These types of materials are well known to those of ordinary skill in the art and these need not be more fully described herein. Between the bodyside liner 32 and the outer cover 20, there is typically some form of liquid retention structure (not shown), such as an absorbent pad made of fibrous absorbent material and superabsorbent material (SAM). An example of such an absorbent pad is shown in co-assigned U.S. Pat. No. 6,383,960. There is also typically a surge layer (not shown) of material that rapidly absorbs liquid passing through the bodyside liner. The surge layer can distribute the liquid over a larger surface area before releasing it to the absorbent pad. Suitable surge layers are described in co-assigned U.S. Pat. Nos. 4,798,603, 5,364,382, 5,429,629, 5,490,846, 5,522,810 and 5,562,650.

To further enhance containment and/or absorption of body exudates, the article 10 may include a front waist elastic member, a back waist elastic member, and leg elastic members, as are known to those skilled in the art. The waist elastic members can be operatively joined to the outer cover 20 and/or body side liner 32 along opposite waist edges, and can extend over part or all of the waist edges. The leg elastic members are desirably operatively joined to the outer cover 20 and/or body side liner 32 along opposite side edges of the diaper 10 and positioned in the crotch region 16 of the diaper.

The waist elastic members and the leg elastic members can be formed of any suitable elastic material. As is well known to those skilled in the art, suitable elastic materials include sheets, strands or ribbons of natural rubber, synthetic rubber, or thermoplastic elastomeric polymers. The elastic materials can be stretched and attached to a substrate, attached to a gathered substrate, or attached to a substrate and then elasticized or shrunk, for example with the application of heat; such that elastic constrictive forces are imparted to the substrate. In one particular embodiment, for example, the leg elastic members include a plurality of dry-spun coalesced multifilament spandex elastomeric threads sold under the trade name LYCRA® and available from E.I. DuPont de Nemours and Company, Wilmington, Del., U.S.A.

To still further enhance containment and/or absorption of any body exudates discharged from the wearer, the diaper 10 may include a pair of containment flaps 34 (only one is shown) which are configured to provide a barrier to the transverse flow of body exudates. A flap elastic member (not shown) may be operatively joined with each containment flap 34 in any suitable manner as is well known in the art. The elasticized containment flaps 34 define an unattached edge that assumes an upright, generally perpendicular configuration in at least the crotch region 16 of the diaper 10 to form a seal against the wearer's body. The containment flaps 34 can be located along the transversely opposed side edges of the diaper 10, and can extend longitudinally along substantially the entire length of the diaper or may only extend partially along the length of the diaper. Suitable constructions and arrangements for the containment flaps 34 are generally well known to those skilled in the art.

The outer cover 20 desirably comprises a material which is substantially liquid impermeable, and can be elastic, extensible or nonstretchable. The outer cover 20 can be a single layer of liquid impermeable material, but desirably comprises a multi-layered laminate structure in which at least one of the layers is liquid impermeable. For instance, the outer cover 20 can include a liquid permeable outer layer and a liquid impermeable inner layer that are suitably joined together by a laminate adhesive, ultrasonic bonds, thermal bonds, or the like. Suitable laminate adhesives, which can be applied continuously or intermittently as beads, a spray, parallel swirls, or the like, can be obtained from Findley Adhesives, Inc., of Wauwatosa, Wis., U.S.A., or from National Starch and Chemical Company, Bridgewater, N.J. U.S.A. The liquid permeable outer layer can be any suitable material and is desirably one that provides a generally cloth-like texture. One example of such a material is a 20 gsm (grams per square meter) spunbond polypropylene nonwoven web. The outer layer may also be made of the same materials as the liquid permeable bodyside liner 32. While it is not a necessity for the outer layer of the outer cover 20 to be liquid permeable, it is desired that it provides a relatively cloth-like texture to the wearer. The outer layer may generally be any suitable nonwoven material as is known in the art.

The inner layer (not shown) of the outer cover 20 can be both liquid and vapor impermeable, or it may be liquid impermeable and vapor permeable. The inner layer can be manufactured from a thin plastic film, although other flexible liquid impermeable materials may also be used. The inner layer, or the liquid impermeable outer cover when a single layer, prevents waste material from welting articles, such as bed sheets and clothing, as well as the wearer and caregiver. A suitable liquid impermeable film for use as a liquid impermeable inner layer, or a single layer liquid impermeable outer cover 20, is a 0.02 millimeter (0.000787 inches) polyethylene film commercially available from Pliant Corporation of Schaumburg, Ill., U.S.A. Alternatively, a suitable liquid impermeable film is a highly breathable film made primarily of polyethylene and calcium carbonate having a basis weight of 19 grams per square meter and a thickness of 0.02 millimeter (0.000787 inches). Such a film is commercially available from Pliant Corporation of Schaumburg, Ill., U.S.A. and is designated Type XP-8635Y.

If the outer cover is a single layer of material, it can be embossed and/or matte finished to provide a more cloth-like appearance. As earlier mentioned, the liquid impermeable material can permit vapors to escape from the interior of the disposable absorbent article, while still preventing liquids from passing through the outer cover. A suitable “breathable” material is composed of a microporous polymer film or a nonwoven fabric that has been coated or otherwise treated to impart a desired level of liquid impermeability. As used herein, the term “nonwoven fabric” refers to a fabric that has a structure of individual fibers or filaments which are interlaid, but not in an identifiable repeating manner. Nonwoven fabrics have been, in the past, formed by a variety of processes known to those skilled in the art such as, for example, meltblowing, spunbonding, wet-forming and various bonded carded web processes. A suitable microporous film is a PMP-1 film material commercially available from Mitsui Toatsu Chemicals, Inc., Tokyo, Japan, or an XKO-8044 polyolefin film commercially available from 3M Company, Minneapolis, Minn. U.S.A. A description of alternative outer cover materials made of extensible materials (so that the outer covers are expandable) can be found in co-assigned U.S. Pat. No. 6,264,641, entitled EXPANDABLE COVER GARMENT, issued Jul. 24, 2001.

In various embodiments, the substrate 101 may be an outer cover 20 of a diaper 10. In the illustrated embodiment of FIG. 4, the diaper 10 has a first graphic 80, a second graphic 82, and a third graphic 84 applied in a front waist region 12 of the outer layer of the outer cover 20 of the diaper 10. In various embodiments, the outer cover 20 may provide a white background on which the graphics 80, 82, or 84 are applied or the background could be other, non-white colors selected for making colors in the graphic stand out. In various embodiments, wherein the outer cover 20 has more than one layer, the graphics 80, 82, and 84 may be applied on an inner layer of the outer cover 20, an outer layer of the outer cover 20, or both. The graphics 80, 82, and 84 may be applied to either side of the layers of the outer cover 20. For example, some, all, or none of the graphics 80, 82, or 84 may be “between” the inner and outer layers of the outer cover 20 after lamination. In a suitable embodiment, the first graphic 80 is applied to an inner layer of an outer cover 20 and the second graphic 82 is applied to an outer layer of the outer cover 20.

In various embodiments, the inner layer and outer layers of the outer cover 20 may be laminated together before, after, or simultaneously with the application of the first graphic 80, the second graphic 82, the third graphic 84, or combinations thereof. In various embodiments, the first graphic 80 may be applied on the same side of the substrate 101 as the second graphic 82, third graphic 84, or both. Alternatively, the first graphic 80 may be applied on the opposite side of the substrate 101 as the second graphic 82, third graphic 84, or both. Alternatively, the first graphic 80, the second graphic 82, the third graphic 84, or combinations thereof may be on both sides of the substrate 101. As used herein, the term “applied on” includes those situations wherein the first graphic 80, second graphic 82, third graphic 84, and/or additional graphics are applied to a first layer of an outer cover 20 and the pigment, ink, colorant, wax, or the like partially or completely penetrates the first layer and deposits partially or completely on the second layer. For example, the pigment, ink, colorant, wax, or the like may be applied on the nonwoven layer of an outer cover 20. The pigment, ink, colorant, wax, or the like may partially or completely penetrate the nonwoven layer and contact the film layer. In such case, the pigment, ink, colorant, wax, or the like would be “applied on” the nonwoven layer even though a portion ultimately was deposited on the film layer. The pigment, ink, colorant, wax, or the like would not be “applied on” the film layer in this example.

In embodiments wherein the substrate 101 is used as a component of an absorbent article, the first graphic 80 may be printed prior to formation of the absorbent article, simultaneously with the formation of the absorbent article, or after the formation of the absorbent article. Similarly, the second graphic 82 and/or third graphic 84 may be printed prior to formation of the absorbent article, simultaneously with the formation of the absorbent article, or after the formation of the absorbent article.

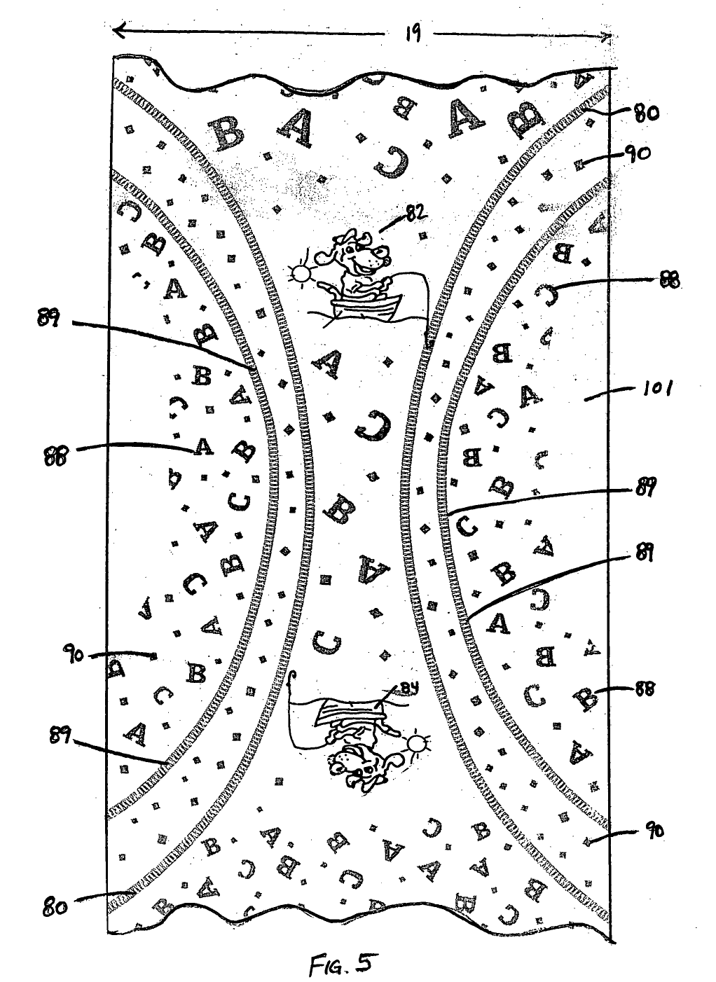

Referring now to FIG. 5, a portion of an exemplary substrate 101, suitable as an outer cover of a diaper, is illustrated. The substrate 101 has a first graphic 80, a second graphic 82, and a third graphic 84. In various embodiments, the first graphic 80 may be a background graphic. As used herein, the term “background graphic” means an image, including components of an image, which provides the scenery or backdrop behind one or more images, such as, for example, a feature graphic. The background graphics can include the part of an image representing what lies behind the image or images in the foreground. Additionally, background graphics can provide a less conspicuous image as compared with the feature graphic. As used herein, the term “feature graphics” refers to graphics by which the product may be easily recognized. Typically, such graphics would constitute the “focus” of the visual markings and generally would consist of greater detail, sharpness, and/or color than those used for background graphics. However, in various embodiments, the background graphics and feature graphics may be equally intense and attractive to a consumer. For example, a first graphic 80, as illustrated in FIG. 5, is as vibrant and attractive as a second graphic 82 and a third graphic 84, but the first graphic 80 could be considered a background graphic, whereas the second graphic 82 and/or third graphic 84 could be considered feature graphics. In some embodiments, the feature graphic or graphics may include, for example, cartoon characters, animals, cartoon animals, vehicles, toys, flowers, numbers, letters, or the like, or combinations thereof.

In various embodiments, the first graphic 80 may span 100% of the width 19 of the substrate 101 as illustrated in FIGS. 5, 6 and 7. As used herein, the term “span” means to extend from one edge to another edge. As seen in FIGS. 5, 6 and 7, the first graphic 80 reaches from one edge of the substrate 101 to the other edge of the substrate 101 thus spanning 100% of the width 19 of the substrate 101. The unprinted spaces within the first graphic 80 do not change the span of the graphic. In alternative embodiments, the first graphic 80 may span at least 90%, 80%, 70%, 60%, 50%, 40%, 30%, 20%, or 10% of the width 19 of the substrate 101. In the illustrated embodiment of FIG. 5, the first graphic 80 comprises subcomponents 88, 89, and 90. The subcomponent 88 includes the letters “A, B, C.” The subcomponent 89 includes four curved lines. The subcomponent 90 includes diamond-shaped objects. In one embodiment, the first graphic 80 is applied during a first converting operation 37. In various embodiments, the second graphic 82, the third graphic 84, or additional graphics may be generally centered along the width 19 of the substrate 101 as illustrated in FIGS. 5, 6, and 7. In various other embodiments, the second graphic 82, the third graphic 84, or additional graphics may be printed within the center ½, ⅓, ¼, or ⅕ of the width 19 of the substrate 101.

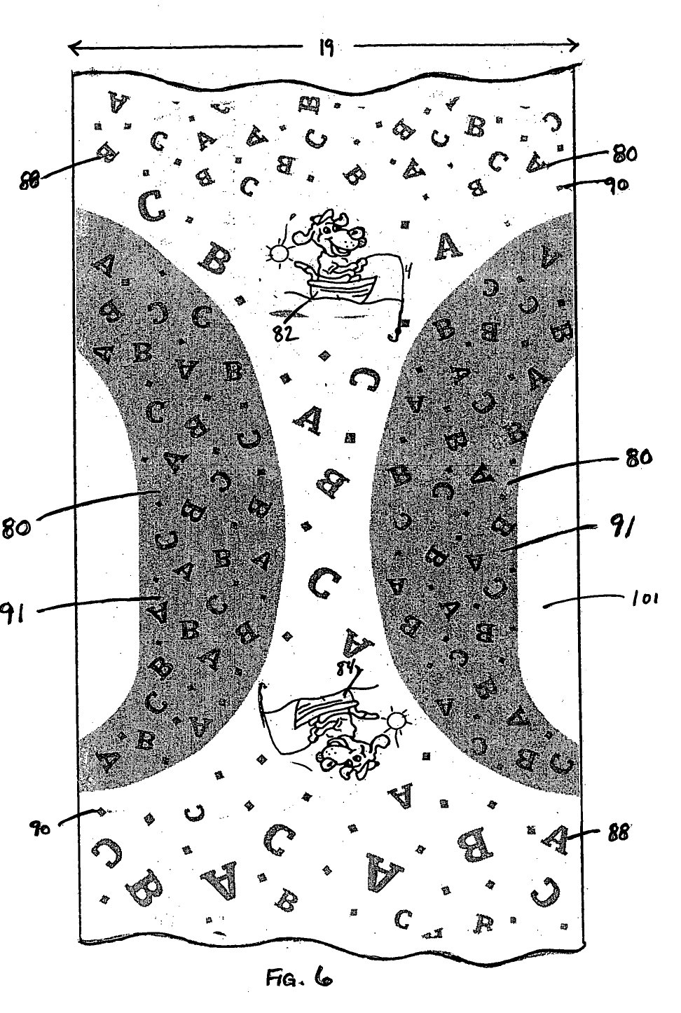

The substrate 101 of FIG. 5 is suitable for use as an outer cover in an absorbent article, such as the outer cover 20 of the diaper 10, as illustrated in FIG. 4. Referring specifically to the embodiments illustrated in FIGS. 5 and 6, the second graphic 82 includes a dog fishing. The third graphic 84 includes the same dog fishing but with the orientation reversed. This orientation of the second graphic 82 and the third graphic 84 is advantageous when manufacturing an absorbent article. For example, the second graphic 82 may be registered such that the second graphic 82 is positioned in the front waist region 12 of an absorbent article 10, such as that illustrated in FIG. 4. Additionally, the third graphic 84 may be registered such that the third graphic 84 is positioned in the back waist region 14 of an absorbent article 10. As such, both the second graphic 82 and the third graphic 84 would be positioned in a “heads up” configuration in the fully assembled diaper. In this embodiment, the second graphic 82 and the third graphic 84 are examples of feature graphics. Similarly, the first graphic 80 may be registered such that subcomponent 89 is centered generally in the crotch region 16 of an absorbent article 10. As such, the subcomponent 89 of first graphic 80 may be registered relative to the leg openings 26.

Referring now to FIG. 6, a portion of a second exemplary substrate 101, suitable for use as an outer cover for an absorbent article, is illustrated. The substrate 101 has a first graphic 80, a second graphic 82, and a third graphic 84 similar to the embodiment illustrated in FIG. 5. However, in FIG. 6, the first graphic 80 comprises subcomponents 88, 90, and 91. Subcomponent 89, curved lines, has been replaced by subcomponent 91, which includes a curved shadow. In a suitable embodiment, the first graphic 80 may be registered such that subcomponent 91 is centered generally in the crotch region 16 of an absorbent article 10. As such, the subcomponent 91 of first graphic 80 may be registered relative to the leg openings 26.

In various embodiments, the graphics may be comprised of different colors. For example, in some embodiments, the first graphic 80 may be comprised of 1 color, 2 colors, 3 colors, 4 colors, 5 colors, 6 colors, 7 colors, 8 colors, 9 colors, 10 colors, 11 colors, or 12 colors. In other embodiments, the first graphic 80 may be comprised of more than 12 colors. In various embodiments, the second graphic 82 may be comprised of 1 color, 2 colors, 3 colors, 4 colors, 5 colors, 6 colors, 7 colors, 8 colors, 9 colors, 10 colors, 11 colors, or 12 colors. In other embodiments, the second graphic 82 may be comprised of more than 12 colors. In various embodiments, the third graphic 84 may be comprised of 1 color, 2 colors, 3 colors, 4 colors, 5, colors, 6 colors, 7 colors, 8 colors, 9 colors, 10 colors, 11 colors, or 12 colors. In other embodiments, the third graphic 84 may be comprised of more than 12 colors. In various other embodiments, more than 3 graphics may be applied.

The present methods may further include non-contact printing means with the capability to change the second graphic 82 and/or third graphic 84 without purchasing or manufacturing new equipment, such as a printing roll, plate, or screen. For example, controllers associated with ink jet printing, bubble jet printing, wax jet printing, laser jet printing, and the like, and combinations thereof, can be programmed to change the second graphic 82, the third graphic 84, and/or additional graphics as desired. For example, the graphics may be part of a story line, may be randomly selected, may be seasonal, may be customized, or the like, or combinations thereof.

As used herein, the term “story line” refers to multiple graphics that when taken as a whole convey a uniform and coherent story or theme. An example of a coherent story may comprise a nursery rhyme wherein the parts of the nursery rhyme are illustrated in sequential graphics applied over sequential absorbent products made by particular methods of the present invention. Alternatively, a story line may include a common background graphic with differing feature graphics all relating to the same theme. In one embodiment, the background graphic includes a pond, shore, and sky. The feature graphics associated with this background graphic may include a boat, people and/or cartoon characters in the boat, fish, people and/or cartoon characters fishing, people and/or cartoon characters swimming or playing on the shore, and the like, and combinations thereof. In this embodiment, the theme is “things associated with a pond.” In another exemplary embodiment, the background graphic may include a flower patch and sky. The feature graphics associated with this background graphic may include people and/or cartoon characters planting seeds and watering. The feature graphics in this story line may also include the flowers in various stages of development, or may depict people and/or cartoon characters playing amongst the flowers, picking the flowers, or the like, and combinations thereof. In this embodiment, the theme is “things associated with a flower patch.”

As used herein, the term “randomly selected” refers to the process of using a controller and a means of generating a random number to select graphics from a list of pre-selected graphics. For example, a background graphic, suitable for use with randomly selected graphics, may include a prairie field and sky. The feature graphics associated with this background, may be randomly selected from graphics of birds, bees, insects, clouds, sunshine, rain, animals, trees, trees with various fruits, flowers, flowers in various stages of development, paths, babies playing and exploring, and the like, and combinations thereof.

As used herein, the term “seasonal” refers to graphics that are changed so as to coordinate with the season and/or a particular region. For example, during the winter the graphics may, for example, depict snow, snow people, sleds, people and/or cartoon characters skiing or ice skating, or the like, or combinations thereof. During the fall, the graphics may depict, for example, leaves changing colors, fallen leaves, piles of leaves, pumpkins, corn stalk bundles, and the like, and combinations thereof. Spring graphics may include, for example, blooming plants, flowers, trees, kites, and the like, and combinations thereof. Summer graphics may include, for example, people and/or cartoon characters swimming, boating, fishing, playing, or the like, or combinations thereof. Additionally, summer graphics may include baseballs, bats, soccer balls, bicycles, and the like, and combinations thereof. One skilled in the art will appreciate that other graphics are possible and the examples illustrated herein are illustrative and not meant to limit the scope of the present invention.

As used herein, the term “customized” refers to graphics that are changed to suit a small demographic, region, customer, or the like. For example, a common background graphic could be utilized for printing outer covers for absorbent articles. The feature graphics could be changed to provide a corporate logo for a limited production run of products for a particular retailer and then changed again to provide a different logo or motif for a second retailer. Additionally, the feature graphics may include various languages that would allow precise customization of products in small markets and/or regions. In such situations, the economy of scale realized when producing a consistent background graphic via contact printing is supplemented by customizing the feature graphics via non-contact printing to satisfy smaller demographics.

Certain aspects of the present invention utilize the capability of non-contact printing to rapidly change the feature graphics while still maintaining the cost effective use of contact printing for background graphics. For example, the first graphic 80 may depict a “standard” background that could accent or supplement various second and third graphics 82 and 84. In the presently illustrated embodiments, the subcomponents 88, 89, 90, and 91 of first graphic 80 can provide a consistent background for second and third graphics 82 and 84. These aspects therefore utilize the consistency of a common background pattern produced at lower costs through traditional contact printing methods while also maximizing the ability to customize the substrate 101 via non-contact printing.

In various embodiments, at least a portion of the second graphic 82 and/or the third graphic 84 overprints at least a portion of the first graphic 80. As used herein, the term “overprint” means to print a second image in the same general location as a first image. Overprinting a second image may obscure the first image or may compliment the first image. As used herein, the term “compliment” means to fill up, complete, or make whole. For example, the first image may form part of a master graphic and the second image may add to, and potentially complete, the master graphic. A master graphic could comprise two or more images that combine to make a single image. As used herein, the term “master graphic” refers to a visual composite, which is built by individual images. For example, a first image may include a flower pot and a second image may overprint flowers in the flower pot. The master graphic would include the visual “whole” of a flower pot containing flowers. A second example of a master graphic includes a first image of a pond with at least one second image of fish overprinted. The master graphic would include the visual “whole” of fish swimming in a pond.

Another example of overprinting involves creating a first image that advertises the absence of a second image. If the second image overprints the first image, the advertisement of the absence is obscured and only the second image is seen. However, if the second image fails to overprint the first image, then the first image will remain visible.

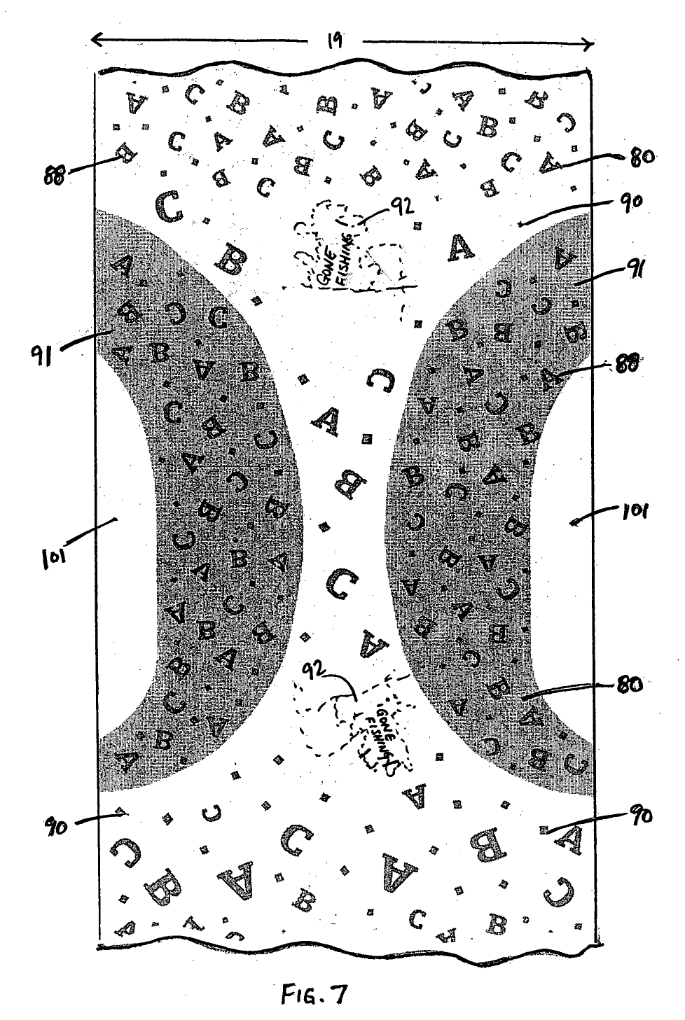

Referring now to FIG. 7, a portion of an exemplary substrate 101, suitable for use as an outer cover of an absorbent article, is illustrated. The substrate 101 includes a first graphic 80. The first graphic 80 includes four subcomponents: 88, 90, 91, and 92. Subcomponents 88, 90 and 91 are similar to those described in FIG. 6 above. However, subcomponent 92 is an absence advertisement. As used herein, an “absence advertisement” is a graphic that conveys the message that an additional graphic is missing. The absence advertisement can take the form of pictures, words, outlines, shadows, or other forms of communication or combinations thereof. Failure to overprint the absence advertisement 92 does not result in a defective substrate or product because the absence advertisement 92 creates a “backup” system for printing. For example, if the second graphic 82 and/or the third graphic 84 overprints the absence advertisement 92, the absence advertisement 92 is obscured and the overprinted graphic is visible in the finished substrate or product. However, if the overprinting fails, the absence advertisement 92 remains visible in the finished substrate or product. As a consequence, the finished substrate or product is not wasted because the absence advertisement 92 is chosen such that the appearance of the absence advertisement 92 in the finished substrate or product would convey a desirable message, such as, for example, a humorous comment, contact information, coupon, or the like, or combinations thereof.

In various configurations, the absence advertisement can be used as a marketing device. For example, in FIG. 7, subcomponent 92 is an absence advertisement. As illustrated, subcomponent 92 includes the dotted outline of a dog, sitting in a boat, with a fishing pole and fishing line. Included within the dotted outline are the words “Gone Fishing!” The combination of the outline figure of the dog and the words within the outline convey the message that the fishing dog is missing, i.e., an absence advertisement. Alternatively, only the dotted outline may be used or only the words may be used. In various embodiments, a second graphic 82 could be overprinted on subcomponent 92. If the overprinting was successful, only the second graphic 82 would be visible (see for example element 82 of FIG. 6) as the absence advertisement is at least partially obscured by the overprinted graphic. However, if the overprinting failed, the subcomponent 92 would be visible in the finished substrate or product, as illustrated in FIG. 7. Despite the printing failure, the resulting substrate and/or product would not be wasted because the absence advertisement 92 could be marketed as, for example, a game or contest. In the illustrated embodiments, a consumer would normally see the second graphic 82 as illustrated in FIG. 6, but would on occasion see subcomponent 92 of the first graphic 80 as illustrated in FIG. 7. The absence advertisement 92 would include the consumer in any such “game” of the missing graphic, thus providing a backup system for printing and therefore reducing waste associated with printing failures. In FIG. 7, the consumer would be included in the search for the missing graphic when they viewed the absence graphic 92. As such, instead of a defective product, the consumer would be notified that the second graphic 82 had “Gone Fishing!” thus turning what was typically considered a product failure into a product attribute.

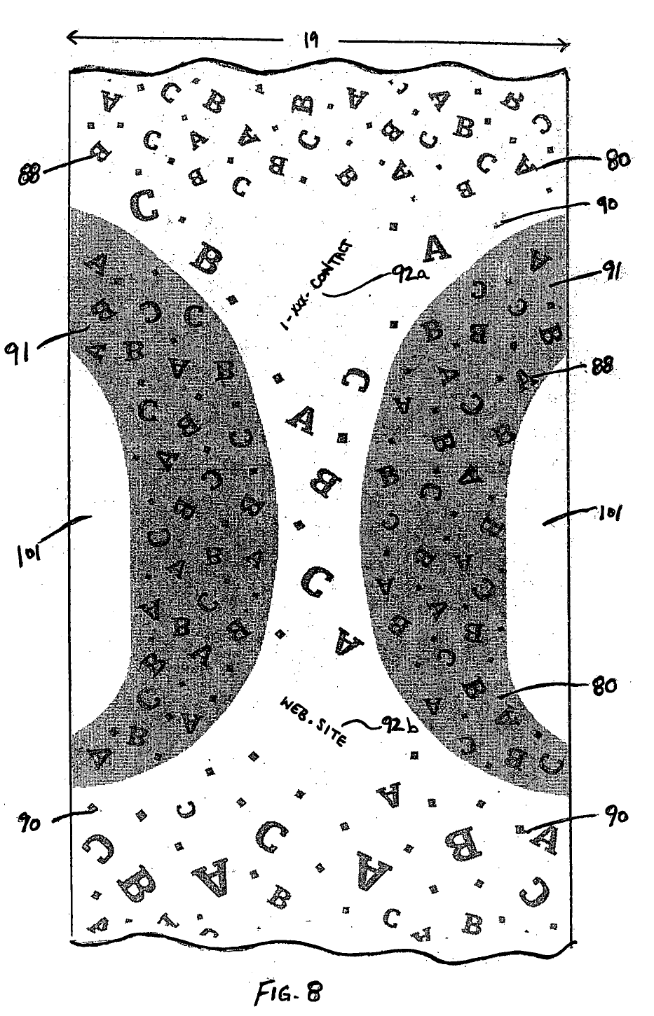

In an alternative embodiment, the absence advertisement 92 may include a consumer contact message. For example, referring now to FIG. 8, a portion of an exemplary substrate 101, suitable for use as an outer cover of an absorbent article, is illustrated. The substrate 101 includes a first graphic 80. The first graphic 80 includes four subcomponents: 88, 90, 91, and 92. Subcomponents 88, 90 and 91 are similar to those described in FIG. 6 above. However, subcomponents 92a and 92b are examples of absence advertisements. The absence advertisement 92a conveys a telephone number graphically depicted as “1-XXX-contact.” Alternatively or additionally, the absence advertisement 92b conveys a web site graphically depicted as “website.” The absence advertisements 92a and 92b provide means of access to the customer service department, wherein, the consumer may register a complaint concerning the missing graphic and/or receive information concerning refunds or coupons. Alternatively, the absence advertisement 92a or 92b may include coupon information associated with the telephone number or website. In such embodiments, the consumer could call or go online to receive a coupon or the like. Those skilled in the art will appreciate that many suitable absence advertisements are possible. Those included herein are illustrative and are not intended to limit the scope of the present invention.

Another aspect of the present invention relates to a method of distributing customized products to different customers. The method includes the steps of supplying a moving substrate to a first converting operation; contact printing at least one first graphic on the moving substrate, the first graphic being substantially uniform to all customers; supplying the moving substrate with the first graphic to a second converting operation; non-contact printing a plurality of second graphics on the moving substrate, the plurality of second graphics being customized for specific customers; and distributing the substrate to customers. As used herein, the term “substantially uniform” refers to a graphic or image that has generally the same appearance as another graphic or image and the differences (if any) between the graphics or images are not noticeable to consumers without being directed to the differences.

In various embodiments of this aspect, the moving substrate with the first graphic may be divided into a plurality of rolls made of portions of the moving substrate prior to supplying the rolled substrate to at least one second converting operation. The moving substrate may be divided by shear cutting, slitting, or any other suitable severing processes as are well known in the art, or combinations thereof. Some rolls of substrate may be printed with one or more second graphics while others may be printed with a different second graphic. Some rolls may be printed with additional graphics in addition to the second graphics. In other embodiments, the plurality of rolls of substrate with only the first graphic may be sent to more than one second converting operation and may be printed with more than one second graphic. The second graphics may be different from one converting operation to another, within a particular converting operation, or both.

One embodiment of distributing customized products to different customers includes the distribution of absorbent articles. In various embodiments, the moving substrate may be an outer cover and the first converting operation may be a contact printing operation such as rotogravure printing, flexographic printing, offset printing, lithographic printing, screen printing, or the like, or combinations thereof. The first graphic may be printed on the outercover using one or more contact printing operations. The first graphic may be substantially uniform to all customers in a given group. A group may be formed based on ethnicity, nationality, location, interests, language, or any other desirable delineation or classification. For example, in FIG. 5, the first graphic 80 may be printed on all outer covers for all customers in the group “North America.” The outer cover may then be supplied with a substantially uniform graphic 80 to one or more second converting operations in one or more locations. In the present example, such converting operations may be one or more diaper converting operations where the outercover is combined with a liner and an absorbent to form a disposable diaper. During the diaper converting operation, one or more second graphics may be non-contact printed on the outer cover. The second graphics may be customized for specific customers. For example, customers within the group “North America” may include Canadian customers, United States of America customers, and Mexican customers. The second graphics may be customized by various non-contact printing methods as previously discussed. Customization may take the form of various languages. For example, the second graphics customized for the Canadian customers may include French and English text, the second graphics customized for the American customers may include English text, and the second graphics customized for the Mexican customers may include Spanish text. The disposable diaper with the substantially uniform graphics and the customized graphics may then be distributed to customers. Alternatively, the outer cover alone may be distributed to customers for the customers' use.

In other examples, the group may be the “world” and the customers may be various continents, countries, regions, or other desirable delineations. Alternatively, the customers may be specific businesses for which the customized graphic or graphics may include various indicia. As used herein, the term “indicia” refers to, for example, a company logo, company trademark, company phrase, licensed characters, proprietary characters, or other desirable marks, or combinations thereof, that are specific or desirable to a particular customer. In such embodiments, contact printing can produce substantially uniform graphics and non-contact printing can result in customized graphics prior to distribution to customers.

As discussed previously, the method of distributing customized products to different customers may include various substrates, including various combinations of laminates. Additionally, the graphics may include background graphics, feature graphics, complimentary graphics, master graphics, and absence advertisements. The graphics may also be part of a story line, may be randomly selected, may be seasonal, or may be customized.

In various embodiments, it may be desirable to align the various graphics through registration as is commonly known in the art. For example, the first graphic, second graphic, third graphic, or combinations thereof may be registered relative to the substrate, a registration mark, or any other graphic by means known in the art. For example, registration by use of a reference marker is taught in U.S. Pat. No. 5,286,543 issued Feb. 15, 1994 to Ungpiyakul et al., the entirety of which is incorporated herein by reference where not contradictory. Additionally, a process for registering two continuously moving layers by use of registration marks is taught in U.S. Pat. No. 5,766,389 issued Jun. 16, 1998 to Brandon et al., the entirety of which is incorporated herein by reference where not contradictory.

While the invention has been described in detail with respect to specific embodiments thereof, it will be appreciated that those skilled in the art, upon attaining an understanding of the foregoing will readily conceive of alterations to, variations of and equivalents to these embodiments. Accordingly, the scope of the present invention should be assessed as that of the appended claims and any equivalents thereto.

1. A method of printing a moving substrate, comprising:
supplying a moving substrate to a first converting operation;
contact printing at least one first graphic on the moving substrate;
supplying the moving substrate with the first graphic to a second converting operation; and
non-contact printing at least one second graphic on the moving substrate.

2. The method of claim 1, wherein the contact printing utilizes a gravure printer, flexographic printer, offset printer, or screen printer.

3. The method of claim 1, wherein the non-contact printing utilizes a wax jet printer, ink jet printer, laser jet printer, or bubble jet printer.

4. The method of claim 1, wherein the first graphic and second graphic jointly form a story line.

5. The method of claim 1, wherein the moving substrate is traveling at least 100 feet per minute during the non-contact printing.

6. The method of claim 1, further comprising: non-contact printing at least one third graphic on the moving substrate, wherein at least a portion of the third graphic at least partially overprints the first graphic.

7. The method of claim 1, wherein the second converting operation produces disposable absorbent articles and the moving substrate forms an outer cover of the articles.

8. The method of claim 1, wherein the second converting operation produces disposable absorbent articles and the moving substrate forms a bodyside liner or an absorbent of the articles.

9. The method of claim 1, wherein the second graphic at least partially overprints the first graphic.

10. The method of claim 1, wherein the first graphic and the second graphic jointly form a master graphic.

11. The method of claim 1, wherein the substrate is a laminate comprising a film layer and a nonwoven layer and the first graphic is printed on the film layer and the second graphic is printed on the nonwoven layer.

12. The method of claim 1, wherein the substrate is a laminate comprising a film layer and a nonwoven layer and the first graphic is printed on the nonwoven layer and the second graphic is printed on the nonwoven layer.

13. The method of claim 1, wherein the substrate is a laminate comprising a film layer and a nonwoven layer and the first graphic is printed on the film layer and the second graphic is printed on the film layer.

14. A method of printing an outer cover for an absorbent article, comprising:
supplying a moving first substrate to a first printing operation, the first moving substrate comprising a film;
contact printing at least one first graphic on the first moving substrate in the first printing operation using a gravure roll printer or flexographic printer;
laminating a second moving substrate to the first moving substrate to form an outer cover, the second moving substrate comprising a nonwoven web and the outer cover defining a width;
supplying the outer cover to a second printing operation;
non-contact printing at least one second graphic on the outer cover in the second printing operation using a wax jet printer, ink jet printer, bubble jet printer, or laser jet printer, the first graphic spanning at least 60% of the width of the outer cover and being visible to the naked eye, the second graphic being positioned within the center third of the width of the outer cover and being visible to the naked eye; and
joining the outer cover with an absorbent and a liner to produce an absorbent article.

15. The method of claim 14, wherein the absorbent article has a front waist region, a back waist region, and a crotch region connecting the front waist region and the back waist region, and the second graphic is positioned within the front waist region.

16. The method of claim 14, wherein the absorbent article has a front waist region, a back waist region, and a crotch region connecting the front waist region and the back waist region, and the second graphic is positioned within the back waist region.

17. The method of claim 14, wherein the absorbent article has a front waist region, a back waist region, and a crotch region connecting the front waist region and the back waist region, further comprising two or more second graphics, at least one second graphic positioned within the front waist region and at least one second graphic positioned within the back waist region.

18. A method of minimizing substrate printing waste, comprising:
supplying a moving substrate to a first converting operation;
printing a plurality of absence advertisements on the moving substrate using a contact printer;
supplying the moving substrate with the absence advertisements to a second converting operation;
at least partially overprinting second graphics on at least some of the absence advertisements using a non-contact printer, wherein a failure to print a second graphic on an absence advertisement results in the absence advertisement remaining visible on the substrate.

19. The method of claim 18, further comprising joining the substrate to an absorbent and to a liner to form an absorbent article, the absence advertisement forming part of an interactive game or contest involving the user of the absorbent article.

20. The method of claim 18, further comprising joining the substrate with an absorbent and a liner to form an absorbent article, the absence advertisement conveying contact information to a consumer of the absorbent article.

21. A method of printing an outer cover for an absorbent article, comprising:
laminating a first substrate comprising film to a second substrate comprising a nonwoven to form an outer cover, the outercover defining a film side, a nonwoven side opposite the film side, and a width;
supplying the outer cover to a printing process and contact printing at least one first graphic on the nonwoven side,
supplying the outer cover to a converting operation, the converting operation combining the outer cover with an absorbent assembly to form an absorbent article;
non-contact printing at least one second graphic on the nonwoven side in the converting operation, the first graphic spanning at least 60% of the width of the outer cover and being visible to the naked eye, the second graphic being positioned within the center third of the width of the outer cover, and both first and second graphics being visible to the naked eye.

22. A method of distributing customized products to different customers comprising:
supplying a moving substrate to a first converting operation;
contact printing at least one first graphic on the moving substrate, the first graphic being substantially uniform to all customers;
supplying the moving substrate with the first graphic to a second converting operation;
non-contact printing a plurality of second graphics on the moving substrate, the plurality of second graphics being customized for specific customers; and
distributing the substrate to customers.

23. The method of claim 22 wherein the customized second graphics being different languages for geographically differentiated customers.

24. The method of claim 22 wherein the customized second graphics being different indicia for business customers.
